(19) United States
(12) Patent Application Publication
(10) Pub. No.: US 2026/0067380 A1
(43) Pub. Date: Mar. 5, 2026

(54) IN-VEHICLE NETWORK SYSTEM, ACTIVATION MESSAGE TRANSFER METHOD, END NODE, AND RELAY NODE

(71) Applicant: DENSO CORPORATION, Kariya-city (JP)

(72) Inventors: Mao YAMAUCHI, Kariya-city (JP); Yasuhiro KOTANI, Kariya-city (JP)

(21) Appl. No.: 19/278,333

(22) Filed: Jul. 23, 2025

(30) Foreign Application Priority Data
Aug. 29, 2024 (JP) 2024-147676

(51) Int. Cl. H04L 69/16; H04L 12/40

(52) U.S. Cl. CPC H04L 69/161; H04L 12/40039; H04L 2012/40273

(57) ABSTRACT

An in-vehicle network system includes: relay nodes each including communication ports; and end nodes each connected to one relay node. Each communication port is connected to a subordinate node. The end nodes include a state management unit configured to transmit an activation message including activation request information indicating an activation cluster to which the end nodes belong and permitted transfer information. The relay nodes include: a storage that stores an activation table that lists information linking node identification information to necessary transfer information; and a rewrite transfer unit configured to decrement a value indicated by the permitted transfer information, delete the activation message, and rewrite the permitted transfer information and transfer the activation message, wherein the necessary transfer information is linked to a target end node belonging to the activation cluster.

### CROSS REFERENCE TO RELATED APPLICATION

The present application claims the benefit of priority from Japanese Patent Application No. 2024-147676 filed on Aug. 29, 2024. The entire disclosure of the above application is incorporated herein by reference.

### TECHNICAL FIELD

The present disclosure relates to an in-vehicle network system.

### BACKGROUND

As a comparative example, a partial network technology has been known, and the technology selectively controls wake-up/sleep states of each ECU connected to an in-vehicle network system.

### SUMMARY

According to an aspect of the present disclosure, an in-vehicle network system includes: relay nodes each including communication ports; and end nodes each connected to one relay node. Each communication port is connected to a subordinate node. The end nodes include at least one of (i) a first circuit and (ii) a first processor with a first memory storing first computer program code executable by the first processor, the at least one of the first circuit and the first processor configured to cause the end nodes to transmit an activation message including activation request information indicating an activation cluster to which the end nodes belong and permitted transfer information. The relay nodes include: a storage that stores an activation table that lists information linking node identification information to necessary transfer information; and at least one of (i) a second circuit and (ii) a second processor with a second memory storing second computer program code executable by the second processor, the at least one of the second circuit and the second processor configured to cause the relay nodes to decrement a value indicated by the permitted transfer information, delete the activation message, and rewrite the permitted transfer information and transfer the activation message, wherein the necessary transfer information is linked to a target end node belonging to the activation cluster.

### BRIEF DESCRIPTION OF THE DRAWINGS

The above and other features of the present disclosure will become more apparent from the following detailed description made with reference to the accompanying drawings, in which like parts are designated by like reference numbers.

FIG. 1 is a block diagram showing a configuration of an in-vehicle network system according to a first embodiment.

FIG. 2 is an explanatory diagram showing a configuration of an IP packet.

FIG. 3 is an explanatory diagram of a function of TTL.

FIG. 4 is an explanatory diagram showing a configuration of an NM message.

FIG. 5 is an explanatory diagram showing an overview of an activation process executed by an activation unit of an end ECU upon receiving the NM message.

FIG. 6 is a flowchart showing a state management process executed by an end ECU.

FIG. 7 is an explanatory diagram showing a setting of a NM table in each zone ECU.

FIG. 8 is a flowchart showing an IP packet process executed by a zone ECU.

FIG. 9 is an explanatory diagram showing a setting of an NM table updated by adding the end ECU and updating a program.

FIG. 10 is an explanatory diagram showing multiple NM tables that are prepared in advance and are selected for use.

FIG. 11 is a block diagram showing a configuration of an end ECU in a second embodiment.

FIG. 12 is an explanatory diagram showing settings of a transfer information table.

### DETAILED DESCRIPTION

In AUTOSAR R22-11: Specification of UDP Network Management, which is a standard for in-vehicle Ethernet networks, it is defined that end nodes periodically transmit NM (network management) messages to control an activation state, and relay nodes transfer NM messages via broadcast. The Ethernet is a registered trademark.

In a case where the NM message is transferred by broadcast, when a loop is formed in the network, the NM message circulates, which causes an increase in the amount of NM message communication.

One aspect of the present disclosure provides a technology for reducing a communication amount of messages related to control of an activation state of a partial network.

According to one aspect of the present disclosure, an in-vehicle network system includes multiple relay nodes and multiple end nodes. Each relay node includes multiple communication ports. Each end node is connected to one of the multiple relay nodes. Each communication port of the multiple relay nodes is connected to a subordinate node that is an end node subordinated to at least one relay node among the multiple end nodes. The end node includes a state management unit. The state management unit is configured to transmit an activation message including activation request information indicating an activation cluster to which the multiple end nodes belong and permitted transfer information in which a permitted number of transfer times is set to one. The relay node includes a storage and a rewrite transfer unit. The storage stores an activation table. The activation table lists, for each end node, information linking node identification information for identifying the end node to necessary transfer information indicating a transfer number required to reach a target node, which is an end node identified by the node identification information among the multiple end nodes. The rewrite transfer unit is configured to decrement a value indicated by the permitted transfer information when the activation message is received via the communication port, and transfer the activation message when the value of the permitted transfer information after decrement is greater than zero. The rewrite transfer unit deletes the activation message when the value of the permitted transfer information after the decrement is zero and also when a transmission source of the activation message is not the subordinate node. The rewrite transfer unit rewrites permitted transfer information of the activation message and transfers the activation message when the value of the permitted transfer information after the decrement is zero and also when a transmission source of the activation message is not the subordinate node. The permitted transfer information is rewritten using the necessary transfer information linked to the target end node, which is an end node belonging to the activation cluster indicated by the activation request information, according to the activation table.

According to this configuration, appropriate permitted transfer information is set in the activation message by the relay node that controls the end node that is the transmission source of the activation message. Accordingly, it is possible to remove activation messages that do not reach their destinations due to the broadcast transfer at an appropriate time. It is possible to reduce the amount of communication of activation messages.

One aspect of the present disclosure is a method for transferring an activation message in an in-vehicle network system. The in-vehicle network system includes multiple relay nodes, each including multiple communication ports, and multiple end nodes, each connected to one of the multiple relay nodes. Each communication port of the multiple relay nodes is connected to a subordinate node that is an end node subordinated to at least one relay node among the multiple end nodes. The transfer method of the activation message includes causing the multiple end nodes to transmit an activation message including activation request information indicating an activation cluster to which the multiple end nodes belong and permitted transfer information in which a permitted number of transfer times is set to one. The transfer method of the activation message includes decrementing a value indicated by the permitted transfer information when the activation message is received via the communication port. The transfer method of the activation message includes transferring the activation message when the value of the permitted transfer information after decrement is greater than zero. The transfer method of the activation message includes deleting the activation message when the value of the permitted transfer information after the decrement is zero and also when a transmission source of the activation message is not the subordinate node. The transfer method of the activation message includes rewriting, according to an activation table, permitted transfer information of the activation message and transfers the activation message when the value of the permitted transfer information after the decrement is zero and also when a transmission source of the activation message is not the subordinate node. The permitted transfer information is rewritten using the necessary transfer information linked to the target end node, which is an end node belonging to the activation cluster indicated by the activation request information. The activation table lists, for each end node, information linking node identification information for identifying the end node to necessary transfer information indicating a transfer number required to reach a target node, which is an end node identified by the node identification information among the multiple end nodes.

By performing such a method, it may be possible to obtain the similar effects to those obtained by the in-vehicle network system described above. According to an aspect of the present disclosure, an end node is connected to any one of multiple relay nodes and configures an in-vehicle network system together with the multiple relay nodes, and the end node includes an activation unit and a state management unit. The activation unit is configured to transition the multiple end nodes from a sleep state to a wake-up state when a preset activation condition is satisfied. The state management unit is configured to transmit an activation message including activation request information indicating an activation cluster to which the end node belong and permitted transfer information in which a permitted number of transfer times is set to one while the end node is in the wake-up state. The wake-up state is a normal operation state where a function of the end node is executable without limitation. The sleep state is a low power consumption operation state where at least a part of the function of the multiple end nodes is limited.

According to such a configuration, it can be used as the end node in the in-vehicle network system described above. One aspect of the present disclosure is a relay node including multiple communication ports. Each of the multiple communication ports of the relay node is connected to a subordinate node that is an end node subordinate to the relay node among multiple end nodes configured to transmit an activation message including activation request information indicating an activation cluster to which the relay node belongs and permitted transfer information indicating a permitted transfer number, or a different relay node different from the relay node. The relay node configures an in-vehicle network system together with the end nodes and the different relay node. The relay node includes a storage and a rewrite transfer unit. The storage and the rewrite transfer unit are configured similarly to the storage and the rewrite transfer unit described in the above in-vehicle network system.

According to such a configuration, it can be used as a relay node in the in-vehicle network system described above.

According to another aspect of the present disclosure, an in-vehicle network system includes: multiple relay nodes each including multiple communication ports; and multiple end nodes each connected to one of the multiple relay nodes. Each communication port of the multiple relay nodes is connected to a subordinate node that is an end node subordinated to at least one of the multiple relay nodes among the multiple end nodes. The multiple end nodes includes: a storage that stores a transfer information table that lists, for each activation cluster, information linking an activation cluster to which the end node belongs to necessary transfer information indicating a transfer number necessary for reaching all of the end nodes belonging to the activation cluster; and a state management unit configured to transmit an activation message including activation request information indicating the activation cluster and permitted transfer information set to the necessary transfer information linked to the activation cluster by the transfer information table. The multiple relay nodes include a rewrite transfer unit configured to decrement a value indicated by the permitted transfer information when the activation message is received via the communication port, transfer the activation message when the value of the permitted transfer information after decrement is greater than zero, and delete the activation message when the value of the permitted transfer information after the decrement is zero.

Hereinafter, embodiments of the present disclosure will be described with reference to the drawings.

### 1. First Embodiment

### (1-1. Configuration)

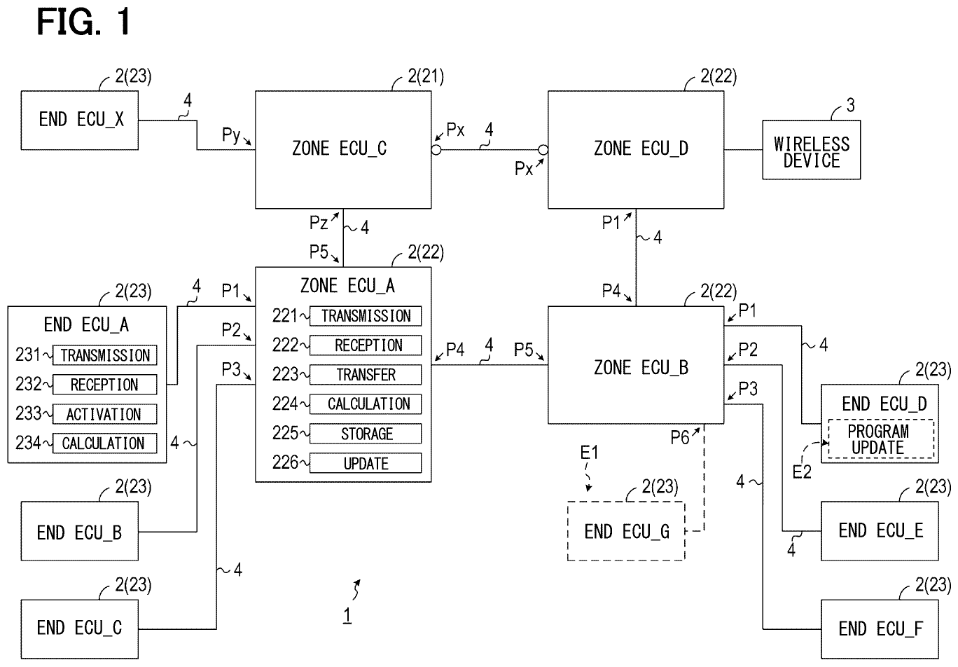

As shown in FIG. 1, an in-vehicle network system 1 according to a first embodiment is connected to multiple electronic control units (hereinafter referred to as ECUs) 2 mounted on a vehicle via multiple transmission paths 4 that communicate using an Ethernet protocol. The Ethernet is a registered trademark.

The ECU 2 has a wake-up state, which is a normal operation state in which its own functions can be executed without limitation, and a sleep state, which is a low power consumption operation state in which at least a part of its own functions is limited. The operation state of the ECU 2 is individually controlled using the NM message. The NM is an abbreviation for Network Management. That is, the in-vehicle network system 1 is configured as a partial network (hereinafter referred to as PN). Further, in the sleep state, the ECU 2 has at least a function of receiving the NM message and transitioning the subject ECU 2 to the wake-up state in accordance with the content of the NM message.

The multiple ECUs 2 are classified into multiple zone ECUs 22, and multiple end ECUs 23. The zone ECU 22 is provided for each zone in which an area in the vehicle is divided. The multiple zone ECUs 22 are connected to each other via transmission paths 4 to form a communication network including redundant paths. Each zone ECU 22 is connected to multiple end ECUs 23 existing in the zone via individual transmission paths 4. The zone ECU 22 controls subordinate end ECUs 23 directly connected to the zone ECU to implement coordinated control in the zone. One of the zone ECUs 22 may function as a central ECU. The central ECU controls the other zone ECUs 22 and implements a coordinated control of the entire vehicle.

In the present embodiment, the vehicle is divided into four zones A to D, and the zone ECUs 22 placed in each zone A to D are referred to as zone ECU_A, zone ECU_B, zone ECU_C, and zone ECU_D. The zones A to D may be in front of the vehicle, in the rear of the vehicle, on one side of the vehicle, and on the other side of the vehicle, respectively. The number of zones is not limited to four, and the area may be divided into two or more zones.

As shown in FIG. 1, the zone ECU_A is connected to the zone ECU_B and the zone ECU_C via separate transmission paths 4. The zone ECU_B is connected to the zone ECU_A and the zone ECU_D via individual transmission paths 4. The zone ECU_C is connected to the zone ECU_A and the zone ECU_D via individual transmission paths 4. The zone ECU_D is connected to the zone ECU_B and the zone ECU_C via individual transmission paths 4. In other words, the multiple zone ECUs 22 are connected in a loop. However, by setting some of the communication ports to which the transmission path 4 is connected as blocking ports, the communication frame is prevented from circulating. In FIG. 1, the communication port to which the transmission path 4 between the zone ECU_C and the zone ECU_D is connected is set as a blocking port. Communication with the blocking port may be prohibited under normal states, and the prohibition may be released in the event of a failure of the ECU 2, the transmission path 4, or the like, for example. That is, the blocking port may be used to ensure redundancy of the communication path. The multiple zone ECUs 22 may be referred to as forming a ring topology.

Three end ECUs 23 are connected to the zone ECU_A in a star shape via individual transmission paths 4. Hereinafter, the end ECU 23 connected to the zone ECU_A is also referred to as an end ECU_A, an end ECU_B, and an end ECU_C. The zone ECU_A and the end ECU_A to C form a switched network (hereinafter referred to as switched NW). Note that the number of end ECUs 23 connected as subordinates in each zone ECU 22 is not limited to the above example, and is arbitrary.

Three end ECUs 23 are connected to the zone ECU_B in a star shape via individual transmission paths 4. Hereinafter, the end ECU 23 connected to the zone ECU_A is also referred to as an end ECU_D, an end ECU_E, and an end ECU_F. That is, the zone ECU_B and the end ECU_D to F form the switched NW.

The zone ECU_C is connected to the end ECU 23 via a transmission path 4. Hereinafter, the end ECU 23 connected to the zone ECU_C will also be referred to as an end ECU_X. The zone ECU_D is connected to a wireless device 3 that communicates with a server or the like on a wide area wireless network. Further, the zone ECU_C may also be connected to one or more end ECUs 23, but for simplicity, the illustration and description thereof will be omitted here.

### (1-2. IP Packet/NM Message)

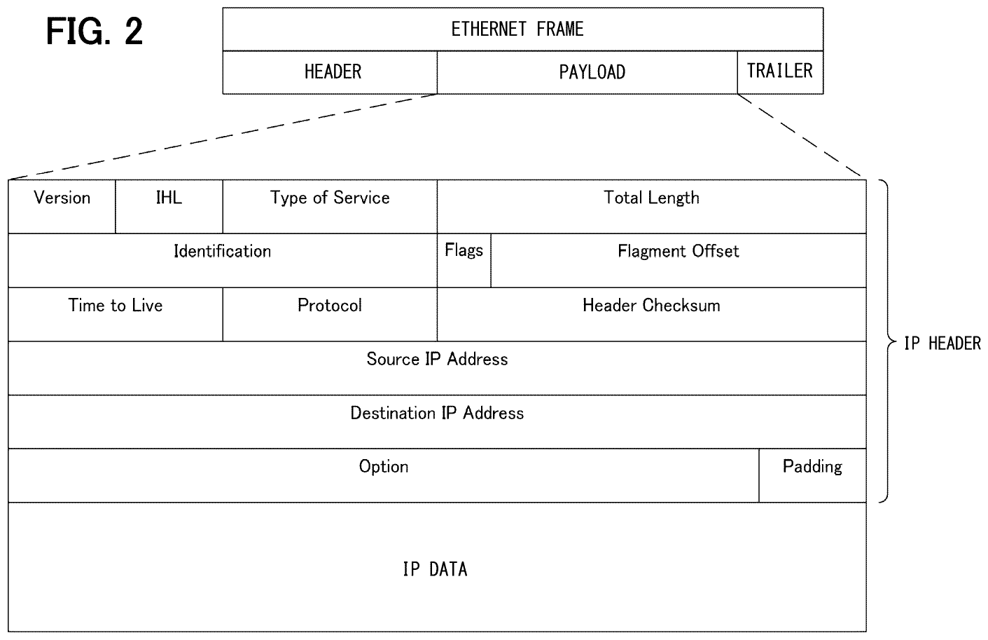

An overview of an IP (internet protocol) packet and the NM message will be described with reference to FIGS. 2 to 5. Note that the NM messages comply with the specifications defined in AUTOSAR R22-11: Specification of UDP Network Management. Note that the applicable specifications are not limited to R22-11. For example, a subsequent version such as R23-11 may also be used.

The NM messages are transmitted and received using Ethernet frames carrying IP packets. As shown in FIG. 2, the Ethernet frame includes a physical header, an Ethernet header, a payload, and a trailer. The physical header is a preamble. The Ethernet header includes a destination address, a transmission source address, and the like. The payload is data and has an IP frame. The trailer is a frame check sequence.

The IP packet includes an IP header and IP data. The IP header includes fields such as version, header length, service type, packet length, identifier, flags, fragment offset, time to live, protocol, header checksum, transmission source IP address, destination IP address, options, and padding.

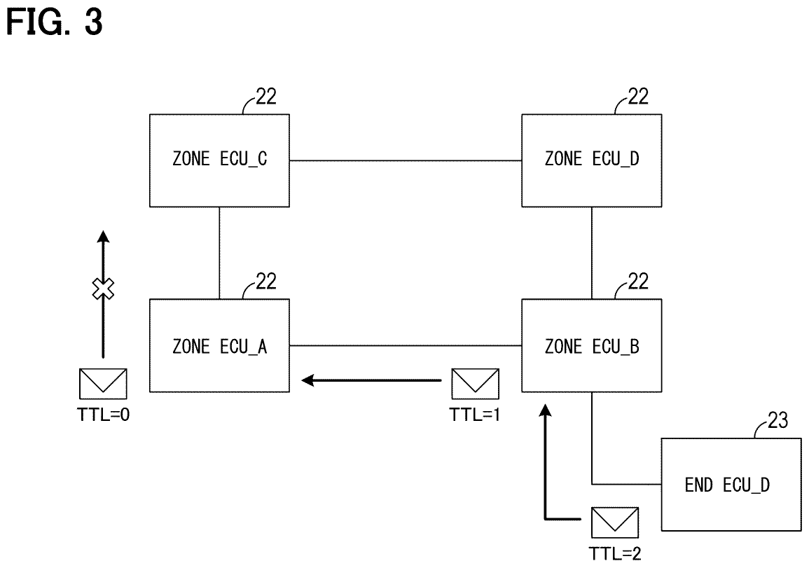

The “Time to Live” field in the IP header is hereinafter referred to as TTL. As shown in FIG. 3, the TTL is set in the end ECU 23 that is the transmission source of the IP packet, and is decremented by one each time the packet is routed within the network. An IP frame whose TTL=0 is reached is discarded without being routed. In this case, the transmission source of the IP packet is notified with an ICMP message called Time Exceed. In other words, by using the TTL function, IP packets are erased after a certain period of time, so that even when a routing loop is formed within the network, the IP packets can be prevented from continuing to circulate.

The “protocol,” which is one of the fields in the IP header, is an field that specifies the protocol that is applied to data that is transmitted and received as IP data. Here, the protocol field is set to use UDP, and the NM message is transmitted and received as IP data.

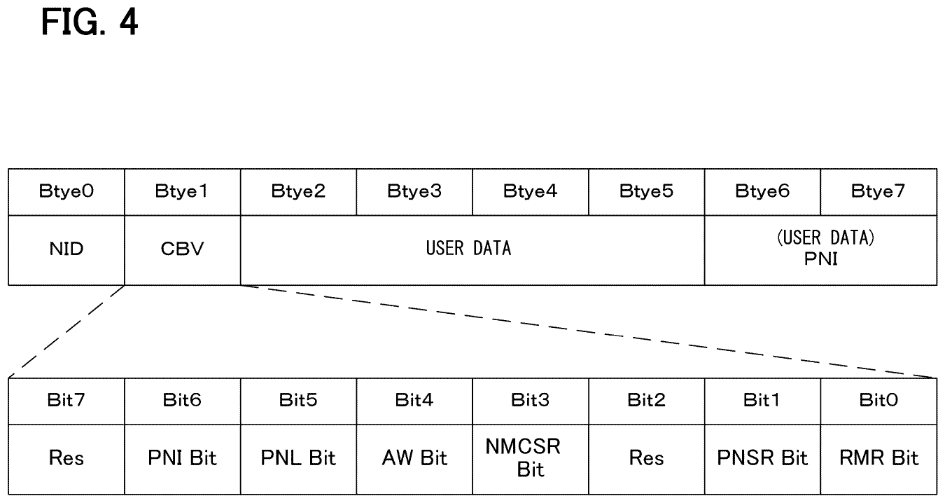

The IP packet is a known technology, and the description of fields other than “TTL” and “Protocol” will be omitted. As shown in FIG. 4, the NM message includes an NID, a CBV, user data, and a PNI. The NID and CBV each consist of one byte. The user data has a variable length, and FIG. 2 shows a case where the user data is 4 bytes. The PNI is variable, and in FIG. 2, the PNI indicates a case of two bytes. The positions of the NID and CBV in the NM message may be reversed.

The NID is an abbreviation for Node Identifier, and is information that identifies the node (that is, the end ECU 23) that is the transmission source of the NM message. The user data is an area where arbitrary data can be set by the user.

The PNI is an abbreviation for Partial Network Information. The PNI is set in the area of user data and represented by multiple bits. Each bit constituting the PNI is called a PNC bit. The PNC is an abbreviation for Partial Network Cluster. The PNC indicates a group (hereinafter referred to as a PN cluster) of end ECUs 23 that need to be activated at the same time of the node (that is, the ECU 2). Each PNC bit is assigned a different PN cluster. A PNC bit whose value is set to 1 indicates that a factor for waking up the PN cluster linked to the PNC bit is occurring. A PNC bit whose value is set to 0 indicates that there is no factor causing the PN cluster linked to the PNC bit to wake up. Hereinafter, the PNI included in the NM message to wake up the ECU 2 will be referred to as PN request information.

The CBV is an abbreviation for Control Bit Vector, which is information indicating the contents of instructions by NM messages. The CBV includes a PNI bit, a PNL bit, an AW bit, a NMCSR bit, a PNSR bit, and a RMR bit. The AW is an abbreviation for Active Weakup. The NMCSR is an abbreviation for NM Coordinator Sleep Ready. The PNSR is an abbreviation for PN Shutdown Request. The RMR is an abbreviation for Repeat Message Request.

The PNI bit is information indicating whether partial network management (hereinafter referred to as partial NM) is supported. In the present embodiment, the PNI bit is fixed to a value indicating that it supports NM. When it is compatible with NM, the user data of the NM message includes PN request information.

The PNL bit is information indicating whether the message is the NM message for PNC learning. The PNL is an abbreviation for Partial Network Learning. The NM message is a standardized, well-known technology, and the AW bit, NMCSR bit, PNSR bit, and RMR bit are not relevant to the main part of the present disclosure, so their description will be omitted.

### (1-3. End ECU)

As shown in FIG. 1, the end ECU 23 includes a transmission unit 231, a reception unit 232, an activation unit 233, and a calculation unit 234.

The transmission unit 231 has a function of transmitting a message generated by the own end ECU 23. The reception unit 232 has a function of receiving messages from other ECUs 2. The activation unit 233 has a function of transitioning the own end ECU 23 to the wake-up state based on the NM message received by the reception unit 232 when the own end ECU 23 is in the sleep state.

The calculation unit 234 has at least a function of monitoring transmission and reception of NM messages while the own end ECU 23 is in the wake-up state, and transitioning the own end ECU 23 to the sleep state as necessary.

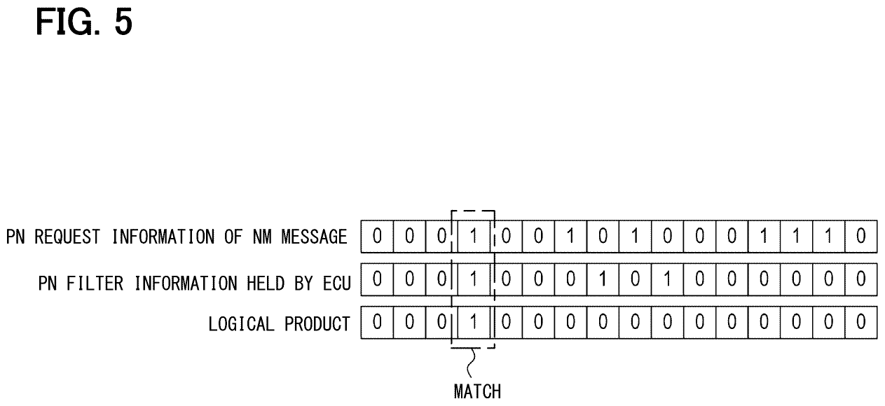

The end ECU 23 holds a PNI (hereinafter, PN filter information) in which all the PNC bits corresponding to the PN cluster to which the own end ECU 23 belongs are set to 1. When the activation unit 233 receives an NM message (hereinafter referred to as a wake-up request) including the PN request information, as shown in FIG. 5, the activation unit 233 compares the PN request information indicated in the wake-up request with the PN filter information of the own end ECU 23 bit by bit. As a result of the comparison, when there is even one matching bit, the activation unit 233 transitions the own end ECU 23 from the sleep state to the wake-up state. The comparison between the PN request information and the PN filter information may be performed by obtaining a logical product of the two information. In this case, when the logical product result is non-zero, the PN request information indicates the PNC to which the own end ECU 23 belongs, in other words, it is determined that a factor for waking up the own end ECU 23 has occurred.

The activation unit 233 may be configured by hardware. When the activation condition is satisfied, the activation unit 233 transitions the subject end ECU 23 from the sleep state to the wake-up state. The activation condition includes at least extracting a wake-up factor (hereinafter referred to as an external factor) based on the received NM message. Further, the activation condition may include the occurrence of a wake-up factor (hereinafter referred to as an internal factor) in the end ECU 23. The activation unit 233 may have a function of notifying the calculation unit 234 of information indicating whether the transition from the sleep state to the wake-up state is due to an external factor or an internal factor.

The calculation unit 234 includes a computer equipped with a CPU and a memory. When the end ECU 23 transitions to the wake-up state, the calculation unit 234 at least executes the state management process. The state management process is a process of maintaining the wake-up state, transitioning to the sleep state, or managing the operation state of the end ECU 23.

### (1-3-1. State Management Process)

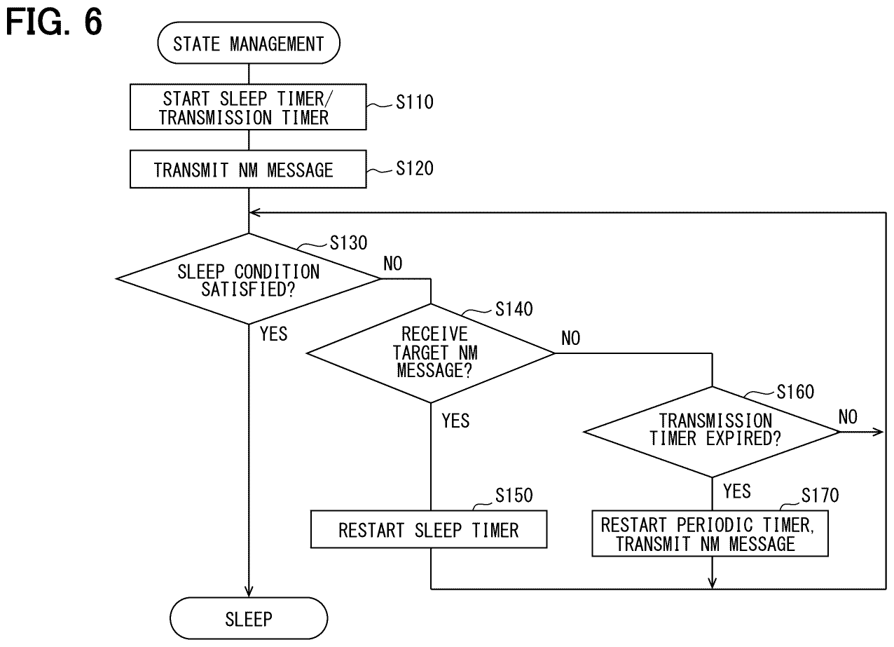

The state management process executed by the calculation unit 234 of the end ECU 23 will be described with reference to a flowchart of FIG. 6.

In S110, the calculation unit 234 starts the sleep timer and the periodic transmission timer. The sleep timer is a timer related to a sleep condition used when transitioning the subject end ECU 23 from the wake-up state to the sleep state. The sleep timer is set to timeout at, for example, 1 second. The periodic transmission timer is a timer that determines the transmission timing of the NM message. The periodic transmission timer is set to timeout at, for example, 10 millimeter seconds. The timeout periods of the sleep timer and the periodic transmission timer are not limited to the above settings, and can be arbitrarily set.

In S120, the calculation unit 234 transmits an NM message including the PN filter information held by the own end ECU 23 as PN request information, the NM being in an IP packet with a TTL value set to 1 in the IP header. Instead of using the PN filter information as the PN request information, a part of the PN filter information may be used as the PN request information depending on the state of the own end ECU 23. For example, the PNC to be activated may be different depending on whether the wake-up is caused by an external factor or an internal factor.

In S130, the calculation unit 234 determines whether the sleep condition is satisfied. One of the sleep conditions includes at least the timeout of the sleep timer. When the calculation unit 234 determines that the sleep condition is satisfied, the process ends, and the subject end ECU 23 transitions to the sleep state. When the calculation unit 234 determines that the sleep condition is not satisfied, the process shifts to S140.

In S140, the calculation unit 234 determines whether an NM message (hereinafter referred to as a target NM message) having PN activation information in which the PNC bit corresponding to the PNC to which the subject end ECU 23 belongs is set to 1 has been received. When the calculation unit 234 determines that the target NM message has been received, the process shifts to S150. When the calculation unit 234 determines that the target NM message has not been received, the process shifts to S160.

In S150, the calculation unit 234 restarts the sleep timer and returns the process to S130. In S160, the calculation unit 234 determines whether the periodic transmission timer has expired. When the periodic transmission timer has expired, the process shifts to S170. When the periodic transmission timer has not expired, the process returns to S130.

In S170, the calculation unit 234 restarts the periodic transmission timer and transmits the same NM message as in S120, that is, the NM message carried in an IP packet with the TTL value set to 1, and then the process returns to S130.

That is, in the wake-up state, the end ECU 23 transmits the NM message at regular intervals based on the setting value of the periodic transmission timer. Further, when the end ECU 23 does not receive the target NM message for a certain period based on the setting value of the sleep timer, the end ECU 23 enters the sleep state.

### (1-4. Zone ECU)

The multiple zone ECUs 22 are all configured in the same manner. As shown in FIG. 1, the zone ECU 22 includes a transmission unit 221, a reception unit 222, a transfer unit 223, a calculation unit 224, a storage 225, and an update unit 226.

The transmission unit 221 has a function of transmitting a message via any of the multiple communication ports of the subject zone ECU 22. The reception unit 222 has a function of receiving messages from other ECUs 2 via any of the multiple communication ports of the subject zone ECU 22.

The transfer unit 223 has a function of transferring messages other than the NM message received from the other ECUs 2 according to the destination indicated in the message. The calculation unit 224 implements a function of deleting unnecessary IP packets by using the TTL of the IP packets, and a function of transferring the received NM message to one or more other communication ports.

Similarly to the calculation unit 234 of the end ECU 23, the calculation unit 224 includes a computer including a CPU and a memory. The calculation unit 224 executes at least IP packet process.

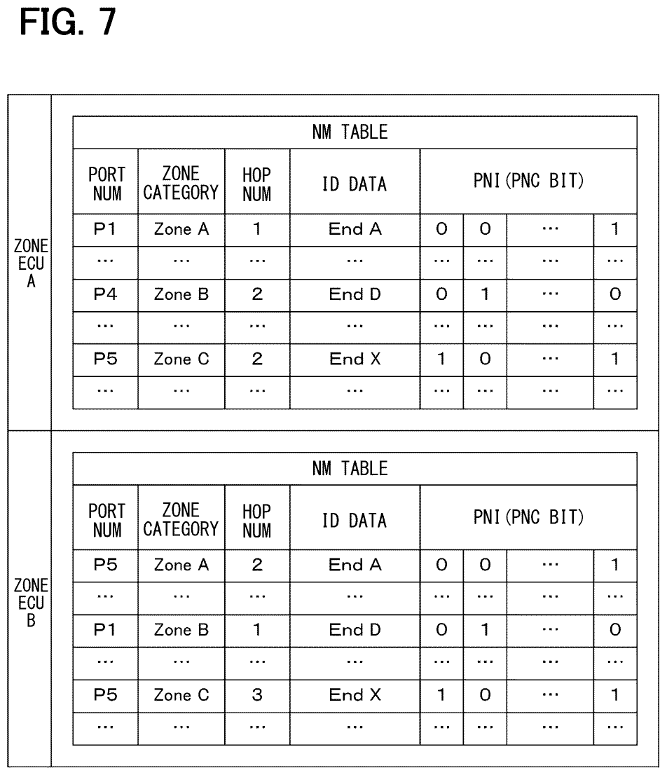

The storage 225 stores the NM table. As shown in FIG. 7, the NM table is a collection of data linked to port numbers, zone categories, hop numbers, node identification data, and PN filter information. In the drawings, the number may be shown as NUM.

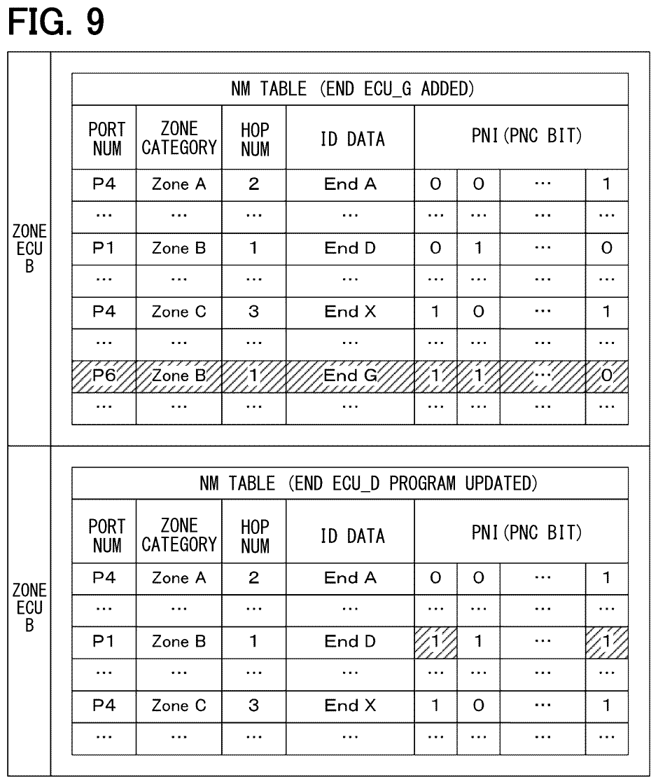

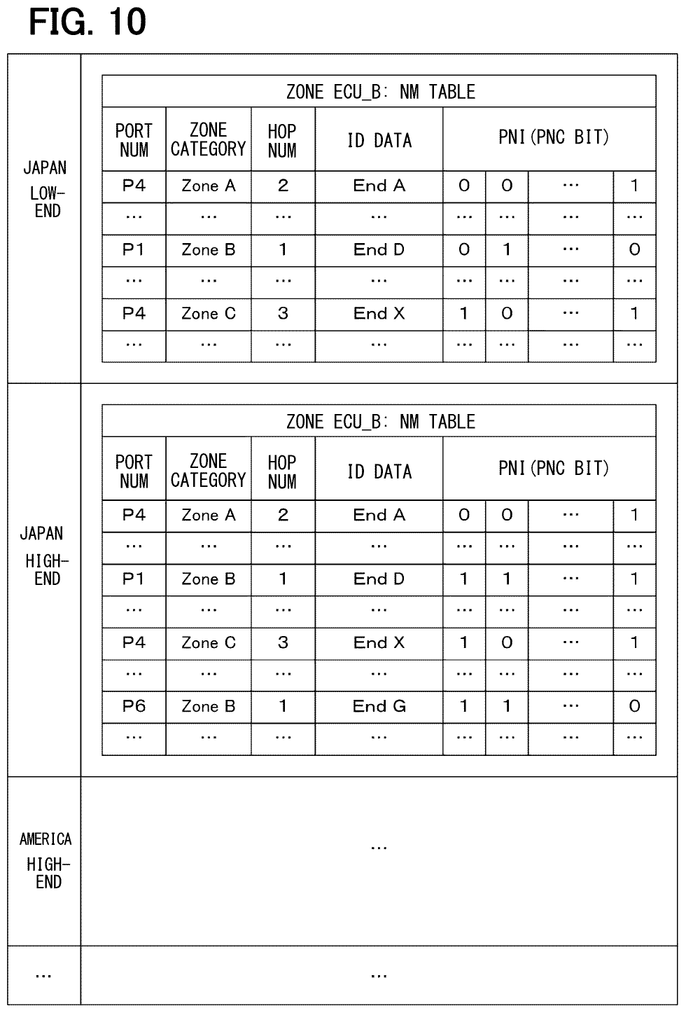

The node identification data is information that uniquely identifies the end ECU 23. The node identification data may be any of a node ID, a MAC address, and an IP address. The NM table lists node identification data for all end ECUs 23 belonging to the in-vehicle network system 1. In FIG. 7, the entry “End A” shown in the node identification data column indicates “End ECU_A”. The same applies to FIGS. 9 and 10 below.

The zone category is information indicating to which zone the end ECU 23 identified by the node identification data (hereinafter referred to as a target end ECU 23) belongs (i.e., is connected to which zone ECU 22).

The port number is information that identifies the communication port connected to the target end ECU 23 or the communication port reaching the zone ECU 22 connected to the target end ECU 23. That is, it is information indicating which communication port can be used to reach the target end ECU 23.

The hop number indicates the number of routings (i.e., the number of transfers) required to reach the target end ECU 23 from the own zone ECU 22. For example, the hop number to a subordinate end ECU 23 connected to the own zone ECU 22 or to an adjacent zone ECU 22 is one, and the hop number to a subordinate end ECU 23 of the adjacent zone ECU 22 is two.

The PN filter information is a PNI indicating which PNC the target end ECU 23 belongs to. As shown in FIG. 7, the NM table is set individually for each zone ECU 22, and all the zone ECUs 22 have the same contents with respect to items other than the port number and the hop number.

Since the end ECUs A to C identified by the node identification data belong to the zone A, the zone category is set to A. Since the end ECUs D to E belong to the zone B, the zone category is set to B. Since the end ECU_X belongs to the zone C, the zone category is set to C.

When the port numbers of the communication ports in each zone ECU 22 and the connection structure between the ECUs 2 are set as shown in FIG. 1, the port numbers and the hop number is set as follows. Focusing on the NM table of the zone ECU_A, as shown in the upper part of FIG. 7, the port number of the communication port leading to the end ECU_A belonging to zone A is set to P1. In addition, since the end ECU_A is directly connected to the communication port P1 of the zone ECU_A, the hop number is set to one. The port number of the communication port leading to the end ECU_D belonging to the zone B is set to P4. In addition, since the end ECU_D is connected to the communication port P4 of the zone ECU_A across the zone ECU_B, the hop number is set to 2. The port number of the communication port leading to the end ECU_X belonging to zone C is set to P5. In addition, since the end ECU_X is connected to the communication port P5 of the zone ECU_A via the zone ECU_C, the hop number is set to 2.

Focusing on zone ECU_B, as shown in the lower part of FIG. 7, the port number of the communication port leading to the end ECU_A belonging to the zone A is set to P5. In addition, since the end ECU_A is connected to the communication port P5 of the zone ECU_B with the zone ECU_A in between, the hop number is set to 2. The port number of the communication port leading to the end ECU_D belonging to the zone B is set to P1. In addition, since the end ECU_D is directly connected to the communication port P1 of the zone ECU_B, the hop number is set to 1. The port number of the communication port leading to the end ECU_X belonging to the zone C is set to P5. In addition, since the end ECU_X is connected to the communication port P5 of the zone ECU_B across the zone ECU_A and the zone ECU_C, the hop number is set to 3.

### (1-4-1. IP Packet Process)

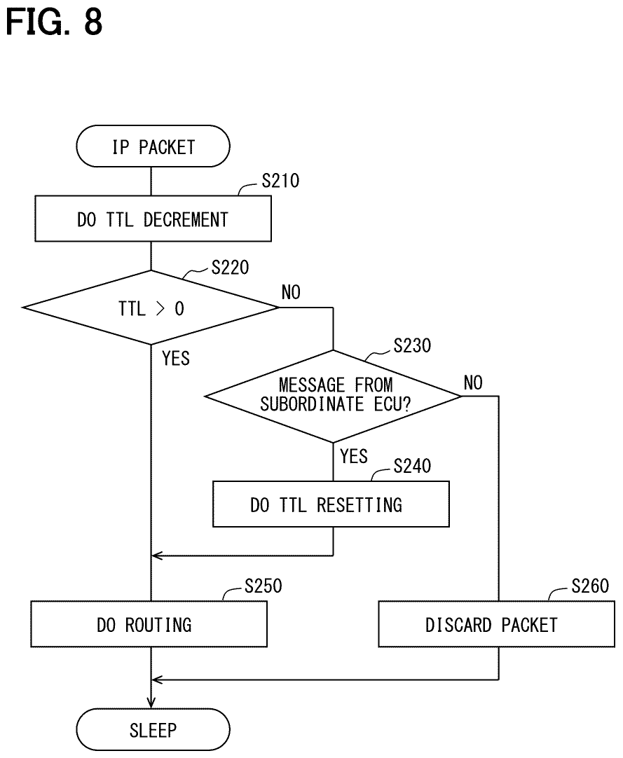

The IP packet process executed by the calculation unit 224 when the zone ECU 22 is in the wake-up state will be described with reference to the flowchart of FIG. 8. The IP packet process is executed every time an IP packet is received via any of the communication ports.

In S210, the calculation unit 224 decrements the TTL value included in the header area of the IP packet by one. In S220, the calculation unit 224 determines whether the TTL value is greater than 0. When the TTL value is greater than 0, the process shifts to S250. When the TTL value is equal to or less than 0, the process shifts to S230.

In S230, the calculation unit 224 determines whether the received IP packet includes the NM message and whether the transmission source is the end ECU 23 subordinated to the own zone ECU 22. The determination as to whether the NM message is included is made by checking the protocol area of the IP header, for example. The transmission source of the NM message is determined, for example, by checking any one of the NID included in the NM message, the transmission source IP address included in the IP header, and the transmission source MAC address included in the header of the Ethernet frame. When the calculation unit 224 determines that the received IP packet includes the NM message from the subordinate end ECU 23, the process shifts to S240. Furthermore, when the calculation unit 224 determines that the received IP packet does not include the NM message from the subordinate end ECU 23, the process shifts to S260.

In S240, the calculation unit 224 resets the TTL value of the received IP packet using the hop number indicated in the NM table, and the process shifts to S250. Specifically, the logical AND is obtained between the PN request information included in the NM message and the PN filter information of each end ECU 23 indicated in the NM table, and those end ECUs 23 for which the calculation result is non-zero are extracted. The TTL value of the received IP packet is reset according to the maximum value among the extracted hop numbers of the end ECUs 23.

In S250, the calculation unit 224 executes the routing process of the IP packet, and then ends the process. In the routing process, when the IP packet carries the NM message, the IP packet is transferred to all communication ports other than the communication port that received the IP packet carrying the NM message. This type of forwarding is called port forwarding. When the IP packet does not carry the NM message, the calculation unit 224 executes routing according to the destination IP address included in the IP header.

In S260, the calculation unit 224 discards the received IP packet, that is, the IP packet whose TTL value has become 0 and whose TTL value has not been reset based on the hop number, and ends the process.

### (1-4-2. Update Unit)

The update unit 226 updates the NM table stored in the storage 225 when a preset update condition is satisfied. The update condition may include adding a new end ECU 23, updating a program installed in the end ECU 23, acquiring update data of the NM table from the outside, and the like. In the present embodiment, the update unit 226 is placed separately from the calculation unit 224, but the update unit 226 may be implemented as a part of the processes executed by the calculation unit 224.

A case will be described where a new end ECU 23 (hereinafter, end ECU_G) is connected to the communication port P6 of the zone ECU_B as indicated by the reference symbol E1 in FIG. 1. When the end ECU_G is activated for some reason, it transmits the NM message including its own PN filter information as PN request information.

The update unit 226 of zone ECU_B refers to its own NM table, and when it detects that the information of the end ECU_G indicated in the received NM message is not registered in the NM table, it adds an item for the end ECU_G to the NM table, as shown in the upper part of FIG. 9. In FIG. 9, the shaded areas are the areas that have been changed from the initial settings of the NM table of the zone ECU_B shown in the lower part of FIG. 7. This added content is also transferred to the other zone ECUs 22, and an item for the end ECU_G is added to the NM table in each zone ECU 22. When an item for the end ECU_G is added to the NM table, in the zone ECU_B to which the end ECU 23 has been added, the zone category is set to the zone B to which the end ECU 23 belongs. The port number is set to P6, which indicates the communication port on which the NM message was received. The hop number is set to 1 since the end ECU_G has been added under the control of the own zone ECU_B. The zone ECU may detect that an end ECU has been added to its control by, for example, service discovery of SOME/IP, which is one of the common service communications in an in-vehicle network. Alternatively, a technique for detecting new communications used in a consumer network may be implemented in the relay device to detect the new communications.

The different zone ECU 22 that has received the update information (i.e., the item of the end ECU_G to be added) updates its NM table in accordance with the update information. Specifically, according to the zone category indicated in the update information, linking information is added to the NM table. The linking information links the port number of the communication port to which the zone ECU_B corresponding to the zone category is connected or to which the zone ECU_B reaches and the item of the end ECU_G that is the update information. The hop number is set to the same value as the hop number set for the other end ECU 23 having the same zone category.

As shown by the reference E2 in FIG. 7, a case will be described in which the PN filter information is changed by updating the program of the end ECU_D under the zone ECU_B. In this case, the end ECU_D transmits an NM message (hereinafter referred to as an update instruction) that includes the changed PN filter information and requests learning of the PNC (i.e., enables the PNL bit). In the zone ECU 22 that has received the update instruction, the update unit 226 updates the PN filter information for the end ECU_D that has been registered in its NM table, as shown in the lower part of FIG. 9, in accordance with the content of the update instruction. Further, the update unit 226 transfers the above update instruction to the different zone ECU 22. Thereby, the NM table is updated in all the zone ECUs 22.

Further, for example, when receiving update data of the NM table from the outside via the wireless device 3, the update unit 226 may update the NM table according to the received update data.

### (1-5. Operation Example)

For example, a case will be described in which the NM message transmitted from the end ECU_D indicates PN request information including the PNC to which the end ECU_X belongs. In this case, the TLL value of the IP packet carrying the NM message transmitted by the end ECU_D is set to 1. The zone ECU_B that receives the IP packet carrying this NM message decrements the TTL value by 1, thereby making the TTL value zero. However, since the IP packet contains an NM message received from the subordinate end ECU_D, zone ECU_B does not discard the IP packet, but resets the TTL value according to the NM table and outputs it to each communication port.

The end ECUs 23 extracted when resetting the TTL value include an end ECU_X. When the hop number of end ECU_X is the largest among the extracted end ECUs, the TTL value of the IP packet to be transferred is set to 3. When this IP packet is transferred to the adjacent zone ECU_A or zone ECU_D, the TTL value is decremented at the transfer destination, and the TTL value becomes 2. However, since the TTL value is not 0, further transfer is performed. As a result, the IP packet reaches the end ECUs A to C and the zone ECU_C. In the end ECUs_A to C, when the PNC that matches the PN filter information held by the end ECU 23 itself is present in the PN request information indicated in the NM packet, the end ECUs_A to C execute a process of waking up the end ECU 23 itself. The TTL value of the IP packet that has reached the zone ECU_C is decremented to 1, and the packet is then transferred to the end ECU_X. Furthermore, the IP packet received via the zone ECU_A is also transferred to the zone ECU_D when the communication port Px is not set as a blocking port. The received IP packet that reaches the zone ECU_C via the path of the zone ECU_D is also transferred to the zone ECU_A when the communication port Px is not set as a blocking port. The IP packet that has reached zone ECU_A, D via zone ECU_C has a TTL value of 0, and is therefore discarded without being forwarded any further.

### (1-6. Correspondence of Terms)

In the present embodiment, the zone ECU 22 correspond to relay nodes in the present disclosure, and the end ECU 23 corresponds to an end node in the present disclosure. In the present embodiment, the PN request information corresponds to activation request information of the present disclosure, the PN filter information corresponds to activation filter information of the present disclosure, and the PNC corresponds to an activation cluster of the present disclosure. In the present embodiment, the NM message corresponds to an activation message of the present disclosure, and the NM table corresponds to an activation table of the present disclosure. In the present embodiment, the hop number corresponds to necessary transfer information of the present disclosure, the TTL value corresponds to permitted transfer information of the present disclosure, and the port number corresponds to path information of the present disclosure. In the present embodiment, the processes of S210 to S260 executed by the calculation unit 224 of the zone ECU 22 correspond to the rewrite transfer unit of the present disclosure. In the present embodiment, the processes of S110 to S170 executed by the calculation unit 234 of the end ECU 23 correspond to the state management unit of the present disclosure.

### (1-7. Effects)

According to a first embodiment described in detail above, the following effects are achieved.
(1a) In the in-vehicle network system 1, the TTL function of the IP packet is utilized, and the end ECU 23 which is the transmission source of the NM message transmits the NM message in the IP packet with the TTL value of 1. The zone ECU 22 decrements the TTL value of the received IP packet. When an NM message is carried in an IP packet whose TTL value has become 0 and the transmission source of the NM message is the end ECU 23 under the own zone ECU 22, the TTL value of the IP packet is reset using the NM table and port transfer is performed. According to the in-vehicle network system 1, it is possible to remove NM messages that do not reach their destinations due to the broadcast transfer at an appropriate time. It is possible to reduce the amount of communication of activation messages.
(1b) In the in-vehicle network system 1, the wireless device 3 is connected to the network via the zone ECU 22, and is configured as an SDV. The SDV is an abbreviation for Software-Defined Vehicle. Therefore, the in-vehicle network system 1 can not only support OTA software download and update, but also support wake-up instructions from the outside of the in-vehicle network system 1. The OTA is an abbreviation for Over The Air.
(1c) According to the in-vehicle network system 1, the NM table held by the zone ECU 22 is updated in response to the addition of the end ECU 23 or an update of a program, so that the system can be flexibly adapted to changes.

### 2. Second Embodiment

(2-1. Difference from First Embodiment)

The fundamental configuration of a second embodiment is similar to that of the first embodiment. Therefore, the difference therebetween will be described below. The same reference numerals as in the first embodiment denote the same elements, and reference is made to the preceding description.

In the first embodiment described above, the end ECU 23 sets the TTL value of the IP packet carrying the NM message to 1, and the zone ECU 23 that receives the NM message from the subordinate end ECU 23 rewrites the TTL value according to the hop number in the NM table and transfers the message. In contrast, the second embodiment differs from the first embodiment in that the end ECU 23 sets the TTL value to the hop number, and the zone ECU 22 only decrements the TTL value and performs the port transfer.

### (2-2. Configuration)

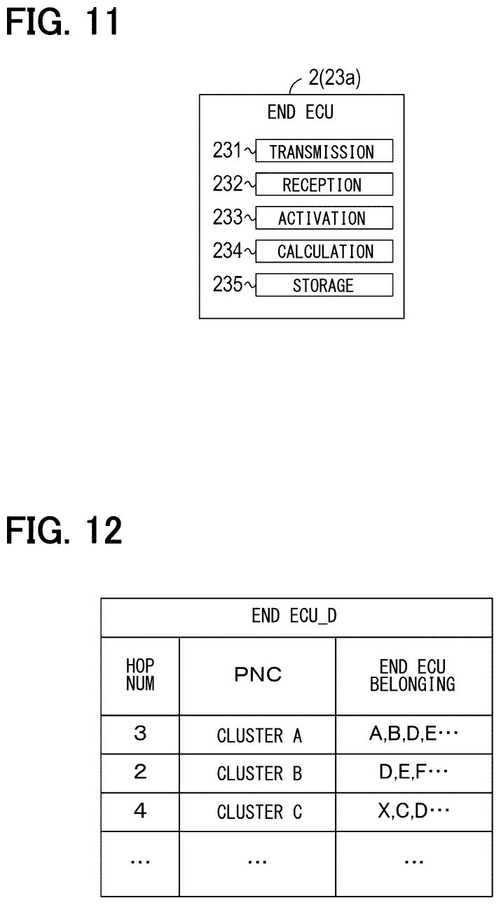

In the second embodiment, the end ECU 23 shown in FIG. 1 is replaced with an end ECU 23a shown in FIG. 11. As shown in FIG. 11, the end ECU 23a includes the transmission unit 231, the reception unit 232, the activation unit 233, the calculation unit 234, and a storage 235.

The storage 235 stores a transfer information table. As shown in FIG. 12, the transfer information table lists information associating the hop number with the PNC for at least all the PNCs to which the own end ECU 23a belongs.

When the connections of the in-vehicle network system 1 are as shown in FIG. 1, the transfer information table of the end ECU_D is set as follows. For example, it is assumed that end ECU_D belongs to cluster A to which end ECU_A, B, C, and D belong, cluster B to which end ECU_D, E, and F belong, and cluster D to which end ECU_X, C, and D belong. In the cluster A, the end ECU_A and B require the maximum number of transfers to reach the destination (hereinafter, the required number of transfers), and the hop number is set to three. In the cluster B, the end ECU_E and F have the maximum of required transfers, and the hop number is set to two. In cluster C, the end ECU_X has the maximum number of required transfers, and the hop number is set to four.

In a case where the calculation unit 234 of the end ECU 23a executes the state management process shown in FIG. 6, when transmitting the NM message in S120 and S170, the calculation unit 234 transmits the NM message using an IP packet in which the hop number linked to the PNC indicated as the PN request information is set as a TTL value in accordance with the forwarding information table.

In the zone ECU 22, the NM table stored in the storage 225 may omit the item of the hop number. When the calculation unit 224 executes the IP packet processing shown in FIG. 8, it executes the processes where S230 and S240 are omitted.

### (2-3. Effects)

The second embodiment described above provides the effects (1b) and (1c) according to the above described first embodiment and the following effect.
(2a) In the second embodiment, an appropriate TTL value is set in the end ECU 23a that is the transmission source of the NM message. Therefore, it is possible to remove the NM messages that do not reach their destination due to broadcast transfer at an appropriate time. It is possible to achieve the same effect as in the first embodiment, that is, reduction of the amount of communication of startup messages while reducing the processing load on the zone ECU 22.

### (2-4. Modification)

The end ECU 23a may further include an update unit that updates the transfer information table. In this case, when the update unit receives information indicating that a new end ECU 23a has been added, the update unit may update the transfer information table in accordance with the received information. The update unit may also update a hop table by receiving update data for the transfer information table from the outside via the wireless device 3 or the like.

### 3. Other Embodiments

Although the embodiments of the present disclosure have been described above, the present disclosure is not limited to the above-described embodiments, and various modifications can be made.
(3a) In the above embodiments, the wireless device 3 is provided separately from the zone ECU 22, but the wireless device 3 may be built into any one or more zone ECUs 22.
(3b) In the above embodiments, the switched network is used as the network topology for connecting the zone ECU 22 and the subordinate end ECU 23. However, a bus network may also be used.
(3c) In the above embodiments, the zone ECU 22 transfers the received NM message to all communication ports other than the communication port through which the NM message was received. The zone ECU 22 may use an NM table to extract the end ECU 23 belonging to the PNC indicated in the PN activation request of the NM message, and transfer the NM message only to the communication port leading to the extracted end ECU 23. In this case, it is possible to reduce the amount of NM message communication.
(3d) In the above embodiment, when resetting the TTL value, the maximum value among the hop numbers of the extracted end ECUs 23 is used to commonly reset the TTL values of all IP packets carrying the NM message. The extracted end ECUs 23 may be classified by port number, and the maximum value among the hop counts of the classified end ECUs 23 may be used, so that the TTL value of the IP packet carrying the NM message may be set to a different value for each communication port.
(3e) In the above embodiment, the TTL of the IP packet is used as the permitted transfer information. However, the NM message may be carried in something other than the IP packet. When a packet other than an IP packet is used, information that implements a function equivalent to TTL may be set in a data area or the like.
(3f) In the above embodiments, it is assumed that only one path leading to each end ECU 23 is registered in the NM table. However, multiple routes may be registered in the NM table. In this case, the communication port with the smallest hop number among the multiple paths related to the target end ECU 23 may be adopted to perform the processing.
(3g) In the above embodiments, each zone ECU 22 uses one NM table. On the other hand, as shown in FIG. 10, for example, multiple types of NM tables may be prepared in advance depending on the equipment situation of the vehicle with the in-vehicle network system 1, such as the destination and the grade of the vehicle. In this case, for example, at the time of shipment, it is possible to select which NM table to use. The NM table may be selected by a dedicated physical switch or by an external instruction via the wireless device 3. Also, the equipment status of the vehicle may be identified from the information flowing through the in-vehicle network system 1, and the NM table may be automatically selected.
(3h) The calculation units 224 and 234 and methods thereof described in the present disclosure may be implemented by a dedicated computer provided by configuring a processor and a memory programmed to execute one or more functions embodied by a computer program. Alternatively, the calculation units 224 and 234 and methods thereof described in the present disclosure may be implemented by a dedicated computer provided by configuring the processor with one or more dedicated hardware logic circuits. Alternatively, the calculation units 224 and 234 and methods thereof described in the present disclosure may be implemented by one or more dedicated computers configured with a combination of a processor and a memory programmed to execute one or more functions, and a processor configured with one or more hardware logic circuits. The computer program may be stored in a computer-readable non-transitory tangible storage medium as instructions to be executed by a computer. The methods of implementing the function of each part included in the calculation units 224 and 234 do not necessarily include software, and all the functions may be implemented using one or more pieces of hardware.
(3i) A multiple functions of one component in the above-described embodiment may be implemented by multiple components, or one function of one component may be implemented by multiple components. Multiple functions of multiple configuration elements may be implemented by one configuration element, or one function implemented by multiple configuration elements may be implemented by one configuration element. Part of the configuration of the above embodiment may be omitted. At least a part of the configuration in one embodiment may be added to or substituted for the configuration of another embodiment.
(3j) In addition to the above-described in-vehicle network system 1, the present disclosure can also be implemented in various forms, such as relay nodes and end nodes that are components of the in-vehicle network system 1, a program for causing a computer to function as the relay node or end node, a non-transitory tangible storage medium such as a semiconductor memory on which this program is stored, and a method for transferring the activation message.

What is claimed is:

1. An in-vehicle network system comprising:
a plurality of relay nodes each including a plurality of communication ports; and
a plurality of end nodes each connected to one of the plurality of relay nodes,
wherein
each communication port of the plurality of relay nodes is connected to a subordinate node that is an end node subordinated to at least one of the plurality of relay nodes among the plurality of end nodes, and
the plurality of end nodes include at least one of (i) a first circuit and (ii) a first processor with a first memory storing first computer program code executable by the first processor, the at least one of the first circuit and the first processor configured to cause the plurality of end nodes to transmit an activation message including
activation request information indicating an activation cluster to which the plurality of end nodes belong and
permitted transfer information in which a permitted number of transfer times is set to one,
the plurality of relay nodes include:
a storage that stores an activation table that lists, for each end node, information linking node identification information for identifying the end node to necessary transfer information indicating a transfer number required to reach a target node, which is an end node identified by the node identification information among the plurality of end nodes; and
at least one of (i) a second circuit and (ii) a second processor with a second memory storing second computer program code executable by the second processor, the at least one of the second circuit and the second processor configured to cause the plurality of relay nodes to
decrement a value indicated by the permitted transfer information when the activation message is received via the communication port, transfer the activation message when the value of the permitted transfer information after decrement is greater than zero,
delete the activation message when the value of the permitted transfer information after the decrement is zero and also when a transmission source of the activation message is not the subordinate node, and
rewrite, according to the activation table, the permitted transfer information of the activation message using the necessary transfer information and transfer the activation message when the value of the permitted transfer information after the decrement is zero and also when the transmission source of the activation message is the subordinate node,
wherein the necessary transfer information is linked to a target end node that is an end node belonging to the activation cluster indicated by the activation request information among the plurality of end nodes.

2. The in-vehicle network system according to claim 1, wherein
the at least one of the first circuit and the first processor is further configured to cause the plurality of end nodes to
transition from a sleep state to a wake-up state when a preset activation condition is satisfied,
transmit the activation message while the end node is in the wake-up state,
the wake-up state is a normal operation state where a function of the plurality of end nodes is executable without limitation, and
the sleep state is a low power consumption operation state where at least a part of the function of the plurality of end nodes is limited.

3. The in-vehicle network system according to claim 1, wherein
when the target end node is a plurality of target end nodes, the at least one of the second circuit and the second processor is further configured to cause the plurality of relay nodes to rewrite the permitted transfer information to a maximum value of the necessary transfer information linked to the plurality of target end nodes.

4. The in-vehicle network system according to claim 1, wherein
the activation table further includes information linking, to the node identification information,
activation filter information that lists the activation cluster to which the target node belongs and
path information, which indicates a communication port leading to the target end node among the plurality of communication ports of the plurality of relay nodes that hold the activation table, and
the at least one of the second circuit and the second processor is further configured to cause the plurality of relay nodes to transfer the activation message only to the communication port leading to the target end node.

5. The in-vehicle network system according to claim 4, wherein
when the target end node is a plurality of target end nodes and also the communication port is a plurality of communication ports linked to the plurality of target end nodes by the path information, the at least one of the second circuit and the second processor is further configured to cause the plurality of relay nodes to transfer the activation message in which the permitted transfer information is rewritten to a maximum value of the necessary transfer information linked to the plurality of target end nodes for each communication port.

6. The in-vehicle network system according to claim 1, wherein
the at least one of the second circuit and the second processor is further configured to cause the plurality of relay nodes to update the activation table when a predetermined update condition is satisfied.

7. The in-vehicle network system according to claim 6, wherein
the update condition includes receiving the activation message from, among the plurality of end nodes, an end node that is not registered in the activation table.

8. The in-vehicle network system according to claim 6, wherein
the update condition includes receiving an update instruction indicating update data of the activation table from, among the plurality of end nodes, an end node registered in the activation table.

9. The in-vehicle network system according to claim 6, wherein
the update condition includes acquiring update data of the activation table from an outside of the in-vehicle network system.

10. The in-vehicle network system according to claim 1, wherein
the activation table is a plurality of types of activation tables,
the plurality of relay nodes
include the plurality of types of activation tables, and
are configured to select and use one of the plurality of types of activation tables according to an equipment device status of a vehicle with the in-vehicle network system.

11. The in-vehicle network system according to claim 1, wherein
the activation message is carried in an internet protocol packet, and
the permitted transfer information is configured to use a time-to-live field included in an internet protocol header.

12. A transfer method of an activation message in an in-vehicle network system comprising: a plurality of relay nodes each including a plurality of communication ports; and a plurality of end nodes each connected to one of the plurality of relay nodes, wherein each communication port of the plurality of relay nodes is connected to a subordinate node that is an end node subordinated to at least one of the plurality of relay nodes among the plurality of end nodes, the method comprising:
causing the plurality of end nodes to transmit an activation message including
activation request information indicating an activation cluster to which the plurality of end nodes belong and
permitted transfer information in which a permitted number of transfer times is set to one;
decrementing a value indicated by the permitted transfer information when the activation message is received via the communication port;
transferring the activation message when the value of the permitted transfer information after decrement is greater than zero;
deleting the activation message when the value of the permitted transfer information after the decrement is zero and also when a transmission source of the activation message is not the subordinate node; and
rewriting, according to an activation table, the permitted transfer information of the activation message using necessary transfer information and transfer the activation message when the value of the permitted transfer information after the decrement is zero and also when the transmission source of the activation message is the subordinate node,
wherein
the necessary transfer information is linked to a target end node that is an end node belonging to the activation cluster indicated by the activation request information among the plurality of end nodes, and
the activation table lists, for each end node, information linking node identification information for identifying the end node to necessary transfer information indicating a transfer number required to reach a target node, which is an end node identified by the node identification information among the plurality of end nodes.

13. An end node that is connected to any one of a plurality of relay nodes and configures an in-vehicle network system together with the plurality of relay nodes, the end node comprising at least one of (i) a circuit and (ii) a processor with a memory storing computer program code executable by the processor, the at least one of the circuit and the processor configured to cause the end node to:
transition the end node from a sleep state to a wake-up state when a preset activation condition is satisfied; and
transmit an activation message including
activation request information indicating an activation cluster to which the end node belong and
permitted transfer information in which a permitted number of transfer times is set to one while the end node is in the wake-up state,
wherein
the wake-up state is a normal operation state where a function of the end node is executable without limitation, and
the sleep state is a low power consumption operation state where at least a part of the function of the end node is limited.

14. A relay node comprising
a plurality of communication ports,
wherein
each of the plurality of communication ports of the relay node is connected to
a subordinate node that is an end node subordinate to the relay node among a plurality of end nodes configured to transmit an activation message including
activation request information indicating an activation cluster to which the relay node belongs and
permitted transfer information indicating a permitted transfer number, or
a different relay node different from the relay node, the relay node configures an in-vehicle network system together with the plurality of end nodes and the different relay node, and
the relay node further comprises:
a storage that stores an activation table that lists, for each end node, information linking node identification information for identifying the end node to necessary transfer information indicating a transfer number required to reach a target node, which is an end node identified by the node identification information among the plurality of end nodes; and
at least one of (i) a circuit and (ii) a processor with a memory storing computer program code executable by the processor, the at least one of the circuit and the processor configured to cause the relay node to
decrement a value indicated by the permitted transfer information when the activation message is received via the communication port, transfer the activation message when the value of the permitted transfer information after decrement is greater than zero,
delete the activation message when the value of the permitted transfer information after the decrement is zero and also when a transmission source of the activation message is not the subordinate node, and
rewrite, according to the activation table, the permitted transfer information of the activation message using the necessary transfer information and transfer the activation message when the value of the permitted transfer information after the decrement is zero and also when the transmission source of the activation message is the subordinate node,
wherein the necessary transfer information is linked to a target end node that is an end node belonging to the activation cluster indicated by the activation request information among the plurality of end nodes.
